(19) United States
(12) Patent Application Publication
(10) Pub. No.: US 2001/0011117 A1
(43) Pub. Date: Aug. 2, 2001

(54) ADDITION CROSSLINKING SILICONE RUBBER MIXTURES, A PROCESS FOR THE PREPARATION THEREOF, A PROCESS FOR THE PREPARATION OF COMPOSITE MOLDED PARTS AND THE USE THEREOF

(76) Inventors: KLAUS-DIETER PESCH, LEVERKUSEN (DE); STEFAN RIST, LEVERKUSEN (DE); HELMUT STEINBERGER, LEVERKUSEN (DE); DIETER WROBEL, LEVERKUSEN (DE)

Correspondence Address: NORRIS,McLAUGHLIN,MARCUS, P.A., 220 East 42nd Sreet, 30th Floor, New York, NY, 10017, US

(21) Appl. No.: 09/071,658

(22) Filed: May 1, 1998

(30) Foreign Application Priority Data
May 2, 1997 (DE) 19718521.5

(51) Int. Cl. C08F 8/00

(52) U.S. Cl. 525/103

(57) ABSTRACT

Addition crosslinking silicone rubber mixtures comprising an alkenyl group—containing organopolysiloxane, a hydrogen siloxane, a Pt or Rh catalyst and an alkoxy silane or alkoxy siloxane.

The present invention relates to addition crosslinking silicone rubber mixtures, to a process for the preparation thereof, to a process for the preparation of composite molded parts comprising crosslinked silicone rubber formed from said mixtures, and to the use thereof.

The addition crosslinking silicone rubber mixtures according to the invention are characterised by good adhesion to substrates and improved reactivity.

It is known to improve the adhesion of addition crosslinking silicone elastomers to various substrates by means of one or more additives which are added to the uncrosslinked silicone rubber mixture. In U.S. Pat. No. 4,087,585, good adhesion to aluminium is achieved, e.g. by the addition of 2 additives, a short-chain polysiloxane with at least one SiOH group and a silane with at least one epoxy group and an Si-bonded alkoxy group. In U.S. Pat. No. 4,906,686, improved adhesion to various plastics is achieved by means of a mixture or a reaction product of (a) a silicon-free compound with at least one alcoholic OH group and at least one alkylene group and (b) an organosilane with at least one alkoxy group and at least one epoxy group, but relatively long reaction times (1 h) at a temperature of 120° C. are required. The long reaction times are frequently caused by the adhesion promoters which have a simultaneous inhibiting effect. According to U.S. Pat. No. 5,164,461, the inhibition due to such additives may be reduced only to a limited degree, even by choosing an optimised SiH/SiVi ratio. The adhesion to aluminium as a substrate is improved, e.g. only after a relatively long vulcanisation time of 2 h (measured at 100° C.). A possible reduction in the reaction times by increasing the temperature may not be carried out on account of the lack of heat resistance, particularly in the case of many plastic substrates.

The object of the present invention is, therefore, to provide addition crosslinking silicone rubber mixtures which, when applied to substrates and crosslinked, have good adhesion to the substrates, and which do not have the previous disadvantages such as poor reactivity or a plurality of additional components.

It has now been found that said object is achieved with addition crosslinking rubber mixtures containing, in addition to the conventional constituents, at least one hydrogen siloxane with at least 20 SiH groups and an alkoxy silane or alkoxy siloxane with at least one epoxy group and, optionally, a peroxide.

The present invention provides, therefore, addition crosslinking silicone rubber mixtures comprising

(a) 100 parts by weight of at least one alkenyl group-containing linear or branched organopolysiloxane with at least 2 alkenyl groups with a viscosity of 0.01 to 30,000 Pas,

(b) at least one hydrogen siloxane with at least 20 SiH functions per molecule in a quantity such that the molar ratio of the SiH groups in the mixture to the total quantity of Si-bonded alkenyl groups in the mixture is at least 1.5,

(c) 1 to 100 ppm of at least one Pt or Rh catalyst, based on Pt or Rh, and optionally 50-10,000 ppm of an reaction rate inhibitor,

(d) 0.1 to 10 parts by weight of at least one alkoxy silane with at least one epoxy group and/or alkoxy siloxane with at least one epoxy group,

(e) 0 to 200, preferably 5-200 parts by weight of at least one, optionally surface-modified, filler

and optionally

(f) 0-10, preferably 0.05-10 parts by weight of further auxiliaries such as e.g. phenyl silicone oils for self-lubricating mixtures or like e.g. 10-70 wt. % of pigments in silicone oil and

(g) optionally 0-1 wt. %, preferably 0.1-0.5 wt. % of at least one peroxide.

The term organopolysiloxane (a) within the meaning of the invention covers all the polysiloxanes used hitherto in crosslinkable organopolysiloxane compositions. (a) is preferably a siloxane of units corresponding to the general formula (I)

(R¹)ₐ(R²)_{b}SiO_{(4—a—b)/2} (1)

wherein

R¹ means a monovalent aliphatic group with 1 to 8 carbon atoms preferably methyl and

R² means an alkenyl group with 2 to 8 carbon atoms, preferably vinyl,

a=0, 1, 2 or 3,

b=0, 1 or 2

and the sum of a+b is 0, 1, 2 or 3,

with the proviso that on average at least 2 groups R² are present per molecule. (a) preferably has dimethylvinylsiloxy chain-stopping groups.

In a preferred embodiment of the invention, the organopolysiloxanes (a) according to the invention have a viscosity of 0.01 to 200 Pas, more particularly 0.2 to 200 Pas.

The viscosity values are determined according to ISO DIS 8961 at 20° C.

Depending on production conditions, particularly in the case of branched polymers which may also be up to 10-80 wt. % solid resins dissolved in solvents, up to a maximum of 10 mol % of all the Si atoms may have alkoxy or OH groups bonded to them. p Hydrogen siloxanes (b) within the meaning of the invention are preferably linear, cyclic or branched organopolysiloxanes of units corresponding to the general formula (II)

(R³)_{c}(H)_{d}SiO_{(4—c—d)/2} (2)

wherein

R³=monovalent aliphatic group with 1 to 8 carbon atoms, preferably methyl,

c=0, 1, 2 or 3,

d 0, 1 or 2,

wherein the sum of c+d is 0, 1, 2 or 3,

with the proviso that on average at least 20 Si-bonded hydrogen atoms are present per molecule.

The hydrogen siloxanes (b) preferably have a viscosity of 0.01 to 5 Pas.

The hydrogen siloxanes (b) may additionally contain organopolysiloxanes of which the number of SiH groups x is 2<x<20.

Catalysts (c) for the crosslinking reaction are preferably Pt(O) complexes with alkenyl siloxanes as ligands like divinyltetramethyldisiloxane or tetravinyltetramethylcyclotetrasiloxane in catalytic quantities of 1 to 100 ppm Pt or 1 to 100 ppm di-μ,μ,′-di-chloro-di(1,5-cyclooctadiene)dirhodium. The Rh compounds that may also be used are the compounds described in J. Appl. Polym. Sci. 30 1837-1846 (1985).

Inhibitors within the meaning of the invention are all the common compounds which have been used hitherto for the purpose of composite mold articles like e.g. alkynole or vinylsiloxanes. Examples of preferred inhibitors are e.g. 1,3-divinyltetramethyldisiloxane, 1,3,5,7-tetravinyl-1,3,5,7-tetramethylcyclo-tetrasiloxane, 2-methylbutinol (2) or 1-ethynylcyclohexanol in quantities of 50 to 10,000 ppm.

Preferred alkoxy silanes or alkoxy siloxanes having at least one epoxy group (d) are those having a maximum of 5 carbon atoms in the alkoxy function.

Mono(epoxyorgano)trialkoxysilanes are particularly preferred, such as eg. glycidoxypropyltrimethoxysilane and siloxanes of the kind described in U.S. Pat. No. 5,623,026, in quantities of 0.1 to 10 parts, based on the sum of all the components.

Fillers (e) within the meaning of the invention are preferably reinforcing fillers such as e.g. pyrogenic or precipitated silica with BET surfaces of between 50 and 400 m²/g which may also be surface-treated to render them hydrophobic, in quantities of preferably 10 to 50 parts, and/or extender fillers, such as e.g. silica flour, diatomaceous earths.

The surface treatment of the fillers may also be carried out in situ by the addition of silazanes such as hexamethylsilazane and/or divinyltetramethyldisilazane and also vinylalkoxy silanes, such as e.g. vinyltrimethoxysilane, and water or other common hydrophobic agents, like alkoxysilanes and siloxane diols.

In a further preferred embodiment of the invention, the mixture contains further auxiliaries (f) such as e.g. phenylsilicones, which yield self-lubricating vulcanisates such as e.g. copolymers of dimethylsiloxy and diphenylsiloxy or methylphenylsiloxy groups and also polysiloxanes with methylphenylsiloxy groups with a viscosity of preferably 0.1-10 Pas up to an amount of 0-10 parts by weight, preferably 0.05-10 parts by weight or pigment pastes.

In a preferred embodiment of the invention, the silicone rubber mixture according to the invention additionally contains at least one peroxide (g) in quantities of 0.1 to 2 parts by weight, based on 100 parts by weight of the total mixture.

Preferred peroxides (g) are aroyl peroxides such as e.g. 2,4-dichlorobenzoyl peroxide and 4-methylbenzoyl peroxide.

The invention also provides a process for the preparation of the addition crosslinking silicone rubber mixtures according to the invention, according to which at least one organopolysiloxane (a) is mixed with at least one filler (e) which may -optionally be rendered hydrophobic, and this is then mixed with further organopolysiloxane (a) and hydrogen siloxane (b), the catalyst (c), the alkoxy silane or alkoxy siloxane (d) and optionally the peroxide (g) and the auxiliaries (f).

Mixing takes place preferably with mixers suitable for highly viscous materials, such as e.g. kneaders, high-speed mixers or planetary mixers.

In a preferred embodiment of the process according to the invention, the filler is rendered hydrophobic, the hydrophobic treatment taking place preferably in situ.

In the in situ hydrophobic treatment, preferably organopolysiloxane (a), filler (e) and the hydrophobic agent, preferably hexamethyldisilazane and/or divinyltetramethyl-di-silazane, are stirred preferably at temperatures of 90-100° C. for at least 20 minutes in a mixing device suitable for highly viscous materials such as e.g. a kneader, high-speed mixer or planetary mixer, and excess hydrophobic agent and water are then removed at T=150-160° C. initially at normal pressure and then under a reduced pressure of about 100 to about 20 mbar. The other components (a), (b), (c), (d) and optionally (f) and (g) are then mixed in over a period of about 10 to about 30 minutes.

The invention also provides a process for the preparation of composite molded parts, particularly of silicone rubber and plastics, glass or metals, from at least one addition crosslinking silicone rubber mixture according to the invention, according to which the addition crosslinking silicone rubber mixture is divided into 2 partial mixtures of which the first contains at least one organopolysiloxane (a), catalyst (c) and optionally fillers (e) and/or auxiliaries (f) and the second contains at least one organopolysiloxane (a), at least one hydrogen siloxane (b), at least one alkoxy silane or alkoxy siloxane with at least one epoxy group (d) and optionally fillers (e), auxiliaries (f) and/or inhibitor (c), and said partial mixtures are combined only in an injection molding machine or in a mixing head arranged upstream followed by a static mixer and bringing said combined material mixtures together with a substrate and then crosslinking said mixture.

The invention also provides a further process for the preparation of composite molded parts from at least one addition crosslinking silicone rubber mixture according to the invention, according to which the addition crosslinking silicone rubber mixture is divided into 3 partial mixtures of which the first contains at least one organopolysiloxane (a), catalyst (c) and optionally fillers (e) and/or auxiliaries (f), and the second contains at least one organopolysiloxane (a), at least one hydrogen siloxane (b), provided that it is not contained in the third, and optionally fillers (e), auxiliaries (f) and/or inhibitor (c) and the third contains at least one alkoxy silane or alkoxy siloxane with at least one epoxy group (d) and optionally hydrogen siloxane (b) provided it is not contained in the second, and also at least one organopolysiloxane (a) and fillers (e), and said partial mixtures are combined only in the injection molding machine or in a mixing head arranged upstream of a mold followed by a static mixer and bringing said combined partial mixtures together with a substrate, and then crosslinking said mixtures.

Conventional common injection molding machines may be used for the process according to the invention.

The quantity ratios of the components used correspond preferably to those that were described for the silicone rubber mixtures according to the invention.

The invention also provides the use of the addition crosslinking silicone rubber mixture according to the invention for the preparation of composite molded parts.

The examples below, in which all the parts mean parts by weight, explain the invention without limiting its scope.

The adhesion of the cured silicone rubber mixtures to various substrates is tested in accordance with ISO 4578 (floating roller peel test) with two specimens in each case at a tensile testing speed of 100 mm/min.

The examples below illustrate the invention without limiting its scope.

### EXAMPLES

### Example 1

In a kneader, 54 parts of polydimethylsiloxane with dimethylvinylsiloxy chain stopping groups (a.1) with a viscosity of 65 Pas and 28 parts of polydimethylsiloxane with dimethylvinylsiloxy chain-stopping groups (a.2) with a viscosity of 10 Pas were mixed with 9 parts of hexamethyldisilazane, 0.2 parts of divinyltetramethyldivinyldisilazane and 3 parts of water, then mixed with 35 parts of pyrogenic silica (e) with a BET surface of 300 m²/g, heated to about 100° C., stirred for about 1 h and then freed from water and excess hydrophobic agent residues at 150 to 160° C. (ultimately under reduced pressure at p=20 mbar) and then diluted with 18 parts of (a.2) and 2 parts of a polydimethylsiloxane with dimethylvinylsiloxy chain- stopping groups (a.3) with methylvinylsiloxy groups having a vinyl content of 2 mmol/g and a viscosity of 0.2 Pas. After cooling, the mixture was mixed with 0.001 parts of a Pt complex compound with alkenylsiloxane as ligand in c) tetramethyltetravinylcyclotetrasiloxane (Pt content: 15 wt. %) and 0.85 parts of ethynylcyclohexanol as inhibitor, and the other components listed in Table 1 were added in the quantities given therein and the mixture was vulcanised for 10 minutes at 175° C. with an inserted 3 mm thick plastic sheet of polyamide (PA 6.6) in a mold about 6 mm thick.

A molded rubber was thereby formed, and was adhered to the plastic sheet. The adhesion strength of the rubber to the plastic was determined in accordance with ISO 4578 (floating roller peel test) with two specimen in each case at a tensile testing speed of 100 mm/min, and the results were as shown (as Adhesion) in Table I.

TABLE 1

| Test | Quantities of | | | | | t₆₀* | Adhesion | |
|---|---|---|---|---|---|---|---|---|
| no. | I | II | III | IV | V | (110° C.) | [N/mm] | SiH/SiVi |
| 1V | 2.9 | — | 3.2 | — | — | 2.3 mm | <0.5 | 2.0 |
| 2V | 2.9 | — | 3.2 | 2.9 | — | | <0.5 | 6.9 |
| 3 | 2.9 | — | — | — | 4.0 | | 3-4 | 7.0 |
| 4 | 2.9 | 2.9 | 3.2 | — | — | | 1-2 | 4.6 |
| 5 | 2.9 | — | 3.2 | — | 2.9 | 1.5 mm | 3-4 | 7.1 |

SiH/SiVi = ratio of SiH to Si-bonded alkenyl
*Vulcameter measurement with Mansanto rheometer MDR 2000, time until 60% cure;
V = comparison

The following abbreviations were used in the Table:

I branched epoxy functional siloxane (d) according to U.S. Pat. No. 5,623,020 (adduct of Example 4)

II linear polydimethylsiloxane with an average content of 20 methylhydrogensiloxy groups and an SiH content of 7.6 mmol/g (b)

III linear polydimethylsiloxane with an average content of 15 methylhydrogensiloxy groups and an SiH content of 5.4 mmol/g (b)

IV linear polydimethylsiloxane with an average content of 15 methylhydrogensiloxy groups and an SiH content of 14.5 mmol/g (b)

V linear polydimethylsiloxane with an average content of 30 methylhydrogensiloxy groups and an SiH content of 15 mmol/g (b).

### Example 2

In a kneader, 47 parts of polymer (a. 1) and 24 parts of polymer (a. 2) were mixed with 9 parts of hexamethyldisilazane, 0.4 parts of divinyltetramethyldivinylsilazane and 3 parts of water and then mixed with 36 parts of pyrogenic silica with a BET surface of 300 m²/g and heated to about 100° C., stirred for about I h and then freed from water and excess hydrophobic agent residues at 150 to 160° C. (ultimately under reduced pressure at p=20 mbar) and then diluted with 25 parts of polymer (a.2) and 1.3 parts of polymer (a.3). After cooling, the mixture was mixed with 1.4 parts of a phenylsilicone oil (f) with a refractive index of 1.5 and a viscosity of 0.3 Pas, 0.001 parts of the complex compound (c) from Example 1 in tetramethyltettavinylcyclotetrasiloxane (Pt content: 15 wt. %), 0.83 parts of ethynylcyclohexanol as inhibitor (c), and the other components listed in Table 2 were added in the quantities given therein and the mixture was vulcanised for 20 minutes at 135° C. with an inserted 3 mm thick plastic sheet in a mold about 6 mm thick.

TABLE 2

Quantities of

| Test no. | VI | V | VII | Adhesion | |
|---|---|---|---|---|---|
| 6V | 2.1 | 2.2 | | <0.5 | N |
| 7V | 2.1 | — | 0.6 | ≦0.5 | N |
| 8 | 2.1 | 2.2 | 0.6 | 3-4 | N |

6V, 7V = comparison

The following abbreviations were used in the Table:

VI linear polydimethylsiloxane with an average content of 18 methyl-hydrogensiloxy groups and an SiH content of 7.0 mmol/g (b)

VII glycidoxypropyltrimethyloxysilane (d)

### Example 3 (according to the invention)

In a kneader, 54 parts of polymer (a.1) and 28 parts of polymer (a.2) were mixed with 9 parts of hexamethyldisilazane, 0.2 parts of divinyltetramethyldivinyldisilazane and 3 parts of water and then mixed with 35 parts of pyrogenic silica (e) with a BET surface of 300 m²/g, heated to about 100° C., stirred for about I h and then freed from water and excess loading medium residues at 150 to 160° C. (ultimately under reduced pressure at p=20 mbar) and then diluted with 18 parts of polymer (a.2). After cooling, the mixture was divided into 2 components. One component was mixed with 2 parts of polymer (a.3) and 0.001 parts of the Pt compound from Example 1 (c) and transferred to a 20 1 drum. The second component was mixed with 3.2 parts of (III) (b) and 0.83 parts of ethynylcyclohexanol as inhibitor and likewise transferred to a 20 1 drum.

The two components were injected in a 2-component metering unit together with 1 vol. % of a paste (M), a mixture of 60 wt. % of the second component +30 wt. % (V) +10 wt. % (VII), via a mixing head followed by a static mixer on an injection molding machine into a mold with an inserted thermoplastic part of polyamide (PA 6.6) and also polybutylene terephthalate (PBT) with and without glass fibres and cured at a mold temperature of 160° C. in 95 s.

The cured silicone rubber mixture adhered very well to the untreated plastics (cohesive failure of the rubber).

A comparative test without paste (M) yielded no adhesion.

### Example 4 (according to the invention)

Example 4 confirms the good adhesion even during relatively rapid vulcanisation at low temperature.

The mixture from Example 1 (without additives from Table 1) was mixed with 3.2 parts (III) and 1.4 parts (VII) and 1.4 parts (V) and vulcanised on a film of polyamide 6.6 for 15 minutes at 110° C. or for 1 h at 90° C.

An adhesion of ≧5 N was achieved in each case.

### Example 5 (according to the invention)

The additives listed in the table below were added to a mixture of the two components according to Example 3 and said mixture used to bond a structural component of aluminium with a plastic (phenolic resin) in which the elastic adhesive was situated in a joint of the plastic part.

Vulcanisation of the mixture was carried out in 10 minutes at 200° C. The following adhesion properties were established:

| Addition | Mixture acc. to invention |
|---|---|
| Paste (M) | 1.4 |
| Peroxide paste* | 0.3 |
| Adhesion | Adhesion (cohesive failure) |

*50 wt. % solution of 2,4-dichlorobenzoyl peroxide in silicone oil

1. An addition crosslinking silicone rubber mixture comprising
(a) 100 parts by weight of at least one alkenyl group-containing linear or branched organopolysiloxane having at least 2 alkenyl groups and a viscosity of 0.01 to 30,000 Pas,
(b) at least one hydrogen siloxane with at least 20 SiH functions per molecule in an amount such that the molar ratio of all the SiH groups in the mixture to the total quantity of Si-bonded alkenyl groups in the mixture is at least 1.5,
(c) at least one Pt or Rh catalyst and optionally an reaction rate inhibitor,
(d) 0.1 to 10 parts by weight of at least one alkoxy silane with at least one epoxy group and/or alkoxy siloxane with at least one epoxy group,
(e) 0 to 200 parts by weight of at least one, optionally surface-modified, filler
and optionally
(f) further auxiliaries and/or
(g) optionally at least one peroxide.

2. Addition crosslinking silicone rubber mixtures according to claim 1, wherein the organopolysiloxane (a) is a siloxane of units corresponding to the general formula (I)
(R¹)ₐ(R²)_{b}SiO_{(4-a-b)/}2 (1)
wherein
R¹ means a monovalent aliphatic group with 1 to 8 carbon atoms and
R² means an alkenyl group with 2 to 8 carbon atoms,
a=0, 1,2or 3,
b=0, 1 or 2
and the sum of a+b is 0, 1, 2 or 3,
with the proviso that on average at least 2 groups R² are present per molecule.

3. Addition crosslinking silicone rubber mixtures according to claim 1, wherein the hydrogen siloxanes (b) are siloxanes of units corresponding to the general formula (II)
(R³)_{c}(H)_{d}SiO_{(4-c-d)/2} (2)
wherein
R³=monovalent aliphatic group with 1 to 8 carbon atoms,
c=0, 1,2or3,
d=0, 1 or 2,
wherein the sum of c+d is 0, 1, 2 or 3,
with the proviso that on average at least 20 Si-bonded hydrogen atoms are present per molecule.

4. Addition crosslinking silicone rubber mixtures according to claim 1, wherein the alkoxy silane (d) is glycidoxypropyltrimethoxysilane.

5. Addition crosslinking silicone rubber mixtures according to claim 1, wherein the mixture contains 2,4-dichlorobenzoyl peroxide and 4-methylperoxide as peroxides.

6. A process for the preparation of the addition crosslinking silicone rubber mixtures according to claim 1, wherein at least one organopolysiloxane (a) is mixed with at least one filler (e), which may optionally be rendered hydrophobic, and said mixture is then mixed with further organopolysiloxane (a) and hydrogen siloxane (b), the catalyst (c), the alkoxy silane or alkoxy siloxane (d) and optionally the auxiliaries (f) and the peroxide (g).

7. A process for the preparation of composite molded parts from at least one addition crosslinking silicone rubber mixture according to claim 1, wherein the addition crosslinking silicone rubber mixture is divided into 2 partial mixtures of which the first contains at least one organopolysiloxane (a), catalyst (c) and optionally fillers (e) and/or auxiliaries (f) and the second contains at least one organopolysiloxane (a), at least one hydrogen siloxane (b), at least one alkoxy silane or alkoxy siloxane with at least one epoxy group (d) and optionally fillers (e), auxiliaries (f) and/or inhibitor (c) and said partial mixtures are combined only in an injection molding machine or in a mixing head arranged upstream of a mold, followed by a static mixer and bringing said combined partial mixtures together with a substrate, and then crosslinking said mixture.

8. A process for the preparation of composite molded parts from at least one addition crosslinking silicone rubber mixture according to claim 1, wherein the addition crosslinking silicone rubber mixture is divided into 3 partial mixtures of which the first contains at least one organopolysiloxane (a), catalyst (c) and optionally fillers (e) and/or auxiliaries (f), the second contains at least one organopolysiloxane (a), at least one hydrogen siloxane (b) provided it is not contained in the third, and optionally fillers (e), auxiliaries (f) and/or inhibitor
(c) and the third contains at least one alkoxy silane or alkoxy siloxane with at least one epoxy group (d) and optionally hydrogen siloxane (b), provided it is not contained in the second, and also organopolysiloxane (a) and fillers (e) and said partial mixtures are combined in an injection molding machine or in a mixing head arranged upstream of a mold followed by a static mixer and bringing said combined partial mixtures together with a substrate, and then crosslinking said mixture.
